(19) United States
(12) Patent Application Publication
(10) Pub. No.: US 2023/0006293 A1
(43) Pub. Date: Jan. 5, 2023

(54) ELECTROCHEMICAL CELL AND METHOD FOR PRODUCING AN ELECTROCHEMICAL CELL

(71) Applicant: ELRINGKLINGER AG, Dettinggen (DE)

(72) Inventors: Mathias WIDMAIER, Magstadt (DE); Elisabeth REITZ, Tübingen (DE)

(21) Appl. No.: 17/941,933

(22) Filed: Sep. 9, 2022

Related U.S. Application Data
(63) Continuation of application No. PCT/EP2021/057114, filed on Mar. 19, 2021.

(30) Foreign Application Priority Data
Mar. 25, 2020 (DE) 10 2020 108 292.4

(51) Int. Cl. H01M 50/195; H01M 10/0525; H01M 50/186; H01M 50/119; H01M 50/102; H01M 50/552; H01M 50/562

(52) U.S. Cl. CPC H01M 50/195; H01M 10/0525; H01M 50/186; H01M 50/119; H01M 50/102; H01M 50/552; H01M 50/562; H01M 2220/20

(57) ABSTRACT

In order to create an electrochemical cell, comprising a housing, an electrochemical element arranged in an interior of the housing, and at least one cell terminal that comprises a terminal feed-through, which extends through a through-opening of the housing, which electrochemical cell is of simple construction and requires a low production expenditure but still reliably limits the short circuit current that arises in the case of a non-regular operating state, it is proposed that the electrochemical cell comprises an electrically conductive sealing element, which seals the through-opening of the housing and electrically conductively connects the cell terminal to the housing.

### RELATED APPLICATIONS

This application is a continuation of international application number PCT/EP2021/057114 filed on 19 Mar. 2021 and claims the benefit of German application number 10 2020 108 292.4 filed on 25 Mar. 2020.

The present disclosure relates to the subject matter disclosed in international application number PCT/EP2021/057114 of 19 Mar. 2021 and German application number 10 2020 108 292.4 of 25 Mar. 2020, which are incorporated herein by reference in their entirety and for all purposes.

### FIELD OF THE DISCLOSURE

The present invention relates to an electrochemical cell, which comprises a housing, an electrochemical element arranged in an interior of the housing, and at least one cell terminal that comprises a terminal feed-through, which extends through a through-opening of the housing.

The electrochemical cell may be, in particular, an accumulator cell or a battery cell.

Lithium-ion battery cells are a key technology for propulsion concepts in electromobility.

In order to protect the electrochemical element, which contains the electrochemically active unit of the cell, for example a lithium-ion battery cell, from harmful environmental influences, the electrochemical unit is enclosed in a gas-tight manner with a cell housing.

In the case of overcharging of the electrochemical cell, large amounts of gases can be released in the interior of the housing. The gases cannot escape through the closed cell housing, which leads to a drastic pressure increase in the housing of the electrochemical cell.

Furthermore, an overcharging of the electrochemical cell causes a self-reinforcing warming of the electrochemical cell, which can lead to an explosive ignition (thermal runaway).

In order to reduce the safety risks associated with an overcharging of the electrochemical cell, an overcharge protection (overcharge safety device, OSD) is installed in the housing of such an electrochemical cell.

In particular in the case of electrochemical cells with a prismatic housing, a snap-over element (also synonymously referred to as a spring element) is often used as an overcharge safety device.

The snap-over element may, in particular, be welded into a housing cover of the housing of the electrochemical cell.

The snap-over element is deflected outwardly at a predetermined internal cell pressure and thereby establishes an electrically conductive connection between the housing cover and the cell terminal with a polarity opposite to the polarity of the housing cover, for example with the negative cell terminal.

The increased internal cell pressure arises due to electrochemical processes and due to the development of heat upon overcharging of the electrochemical cell. Because the housing lid is at the opposite electrical potential, for example at the potential of the positive cell terminal, the electrochemical cell is short circuited by the contact of the snap-over element with the cell terminal. The short circuit can, for example, trigger a fuse.

After the fuse is triggered, there is no longer an electrical connection between the cell terminal, in the connecting conductor of which the fuse is arranged, and the electrochemical element in the interior of the housing of the electrochemical cell, such that the electrochemical cell cannot be charged further. This prevents further overcharging of the cell.

Because the snap-over element contacts the cell terminal associated with same only at a small point of contact and the snap-over element is typically made from a thin metal sheet in order to enable the snapping-over of the snap-over element, the current-carrying cross section of the contact between the triggered snap-over element and the associated cell terminal is small. This can result in a significant development of heat, which can lead to damage to the snap-over element. This can result in the fuse no longer being able to be triggered, such that the short circuit current path is interrupted and the electrochemical cell continues to be overcharged despite activation of the snap-over element and is brought into a critical state.

In order to prevent the snap-over element from being destroyed when the short circuit is triggered, it is known to arrange an additional current-limiting resistor between the further cell terminal, which is not associated with the snap-over element, for example the positive terminal, and the housing of the electrochemical cell. The terminal feed-through of the further cell terminal is not welded directly to the housing of the electrochemical device, but rather is guided through a through-opening in the housing of the electrochemical device in an electrically insulated manner. The current-limiting resistor is arranged on the outside of the housing of the electrochemical device between the further cell terminal on the one hand and the housing, for example a cover of the housing, of the electrochemical device on the other hand. When the snap-over element is triggered, the current thereby flows via the further cell terminal through the current-limiting resistor to the housing of the electrochemical device, thereby limiting the short circuit current when the spring element is triggered. This increases the operational safety of the cell, because as a result the current flowing to the housing in the normal operating state is limited and the risk of an electrical shock, for example when the housing of the electrochemical device is unintentionally contacted, is reduced.

However, this known structure requires a multitude of components, in particular a resistance plate, the further cell terminal, seals, and insulation on the terminal feed-through.

This multitude of components requires a corresponding number of process steps in the production of the assembly of terminal, current-limiting resistor, and housing of the electrochemical device. This leads to high production cycle times and production costs.

### SUMMARY OF THE INVENTION

In accordance with an embodiment of the invention, an electrochemical cell of the kind stated at the outset is created, which is of simple construction and requires a low production expenditure but still reliably limits the short circuit current that occurs in the case of a non-regular operating state.

In accordance with an embodiment of the invention, provision is made in an electrochemical cell with the features of the preamble of claim 1 that the electrochemical cell comprises an electrically conductive sealing element, which seals the through-opening of the housing and electrically conductively connects the cell terminal to the housing.

In a preferred embodiment of the electrochemical cell in accordance with the invention, provision is made that the sealing element comprises a plastic material.

For example, provision may be made that the sealing element comprises a thermoplastic material and/or a thermoset material.

In a preferred embodiment of the invention, provision is made that the sealing element comprises a polypropylene material, a polybutylene terephthalate material, and/or an epoxy resin material.

The electrically conductive sealing element forms an ohmic resistance between the cell terminal and the housing, which is preferably at least 1·10¹Ω and/or preferably at most 1·10⁷Ω.

The material of the electrically conductive sealing element has a specific electrical conductivity that is preferably at least 10⁻³ S/m, particularly preferably more than 10⁻² S/m, and/or preferably at most 10³ S/m, particularly preferably less than 10⁻¹ S/m.

For producing the electrical conductivity of the sealing element, provision may be made that the sealing element comprises an electrically conductive additive.

Such an electrically conductive additive may comprise, e.g., metallic particles, an electrically conductive carbon modification (for example graphite, conductive soot, graphene, carbon nanotubes, carbon fibers, and/or carbon nano-onions), and/or an electrically conductive ceramic material (for example a nitride or a carbide).

Alternatively or in addition to using a conductive additive as part of the sealing element, provision may be made that the sealing element comprises a plastic material made electrically conductive by doping.

For example, provision may be made that the sealing element comprises a doped polyacetylene material, a doped polypyrrole material, a doped polyaniline material, a doped poly(p-phenylene) material, a doped polythiophene material, a doped poly-3,4-ethylenedioxythiophene, and/or a doped polystyrene sulfonate (PEDOT:PSS).

The sealing element is producible in a particularly simple manner if it is configured as an injection molded part or as a casting compound part.

The cell terminal on which the sealing element is arranged may be, in particular, a positive cell terminal (cathode) of the electrochemical cell.

In a preferred embodiment of the invention, provision is made that the electrochemical cell comprises, in addition to the cell terminal on which the sealing element is arranged, a further cell terminal and a snap-over element, which brings the housing of the electrochemical cell into electrically conductive contact with the further cell terminal when a pressure in the interior of the housing of the electrochemical cell exceeds a threshold pressure value.

The housing of the electrochemical cell preferably comprises aluminum and/or a stainless steel material.

In particular, provision may be made that the housing of the electrochemical cell comprises aluminum as its main component or comprises a stainless steel material as its main component.

A particularly simple structure for the cell terminal is achieved if the cell terminal comprises a bent sheet metal part.

Such a sheet metal part can be separated out, for example punched out or cut out—e.g. by means of a laser—from a metal sheet of a suitable starting material and then bent into the desired form.

The bent sheet metal part may have, for example, a substantially S-shaped or a substantially Z-shaped longitudinal section.

The starting material from which the sheet metal part is separated out may have a material transition, in particular between a first region that is made, e.g., primarily of aluminum, and a second region that is made, e.g., primarily of copper.

These two regions of the starting material for the sheet metal part may be connected to one another, e.g., by overlap roll cladding.

By using a bent sheet metal part as a constituent part of the cell terminal, the number of components required for the cell terminal and the expenditure for the production of the cell terminal can be reduced.

Furthermore, provision may be made that the cell terminal comprises an elastically deformable region.

Forces acting on the sealing element or on the cell terminal, which are generated, e.g., by a movement of the electrochemical element of the electrochemical cell upon an impact load, can be absorbed by such an elastically deformable region without the sealing function of the sealing element being impaired.

Provision is preferably made that the elasticity of the elastically deformable region is based on a dimensional elasticity that is caused by the elastically deformable region comprising at least one bend, in particular at least two bends, particularly preferably at least three bends, for example at least four bends.

It is particularly favorable if the bends of the elastically deformable region produce a wave shape of the elastically deformable region.

The present invention further relates to a method for producing an electrochemical cell, wherein the electrochemical cell comprises a housing, an electrochemical element arranged in the interior of the housing, and at least one cell terminal, which comprises a terminal feed-through.

In accordance with an embodiment of the invention, a method for producing an electrochemical cell is provided, by means of which an electrochemical cell is created that has a simple structure and still reliably limits a short circuit current that arises in a non-regular operating state of the electrochemical cell.

In accordance with an embodiment of the invention, a method for producing an electrochemical cell is provided, which comprises the following:
arranging the cell terminal relative to the housing in such a way that the terminal feed-through extends through a through-opening of the housing;
producing an electrically conductive sealing element, which seals the through-opening and electrically conductively connects the cell terminal to the housing, from a plastic material that comprises an electrically conductive additive and/or is made electrically conductive by doping.

Preferred embodiments of the method in accordance with the invention have already been described above in conjunction with the particular embodiments of the electrochemical cell in accordance with the invention.

The method in accordance with the invention is suited in particular for producing an electrochemical cell in accordance with the invention.

The electrochemical element of the electrochemical cell may be configured, in particular, as a cell coil impregnated in electrolyte.

The electrochemical cell is preferably configured as a lithium-ion accumulator cell.

In particular, provision may be made that the cell chemistry of the electrochemical cell is based on Li₄Ti₅O₁₂.

The electrochemical cell in accordance with the invention is suited, in particular, for use in a module that comprises a plurality of electrochemical cells.

Such a module may be used, for example, as an energy source for an electric vehicle, in particular an electric car.

In a preferred embodiment of the invention, provision is made that a starting material from which the sealing element is made is injected or cast directly around the cell terminal and a region of the housing of the electrochemical cell.

If the material of the sealing element is made by adding an electrically conductive additive to a plastic material, the electrical conductivity (and thus the degree of current limitation by the sealing element) can thereby be set in a targeted manner by the proportion of the electrically conductive additive in the material of the sealing element.

If the sealing element is made of a plastic material made electrically conductive by doping, the electrical conductivity of the sealing element can thereby be set by the doping level of the plastic material.

Upon triggering a snap-over element, the current flows from the terminal on which the sealing element is arranged, through the electrically conductive sealing element, to the housing of the electrochemical device. As a result of the lower electrical conductivity of the material of the sealing element in comparison to metals, this current is effectively limited. Damage to the snap-over element due to too high a short circuit current is hereby prevented. In addition, the operational safety of the electrochemical cell is increased, since the current is limited in the case of an unintentional contact of the housing of the electrochemical device and thus the risk of an electrical shock is reduced.

If the sealing element is made of a thermoplastic material, the sealing element is preferably produced by injection molding.

If the sealing element is made of a thermoset material, the sealing element is preferably produced by a casting process.

In both cases, the number of components required for the structure of the electrochemical cell is reduced and the cycle times in the production of the electrochemical cell are reduced, which results in a reduction of costs.

The electrically conductive sealing material performs two functions simultaneously, namely, for one, the sealing of the terminal feed-through of the cell terminal and, for another, the limitation of the electrical short circuit current that flows from the cell terminal to the housing of the electrochemical cell, for example when the snap-over element is triggered.

Further features and advantages of the invention are subject matter of the subsequent description and the graphical representation of exemplary embodiments.

### BRIEF DESCRIPTION OF THE DRAWINGS

FIG. 1 shows a schematic longitudinal cut through an electrochemical cell of an electrochemical device, the cut plane running through an electrochemical element, a housing, two cell terminals, two connecting conductors, which each electrically conductively connect a cell terminal to the electrochemical element, a sealing element, which seals the through-opening of the housing and electrically conductively connects one of the cell terminals to the housing, an insulating element, which electrically insulates a further cell terminal of the electrochemical cell from the housing, and a snap-over element, which brings the housing of the electrochemical cell into electrically conductive contact with the further cell terminal when a pressure in the interior of the housing exceeds a threshold pressure value, the electrochemical cell being in a normal operating state in which the snap-over element is at a distance from the further cell terminal;

FIG. 2 shows a schematic longitudinal cut, corresponding to FIG. 1, through the same electrochemical cell in a short circuit state in which the snap-over element electrically conductively connects the housing of the electrochemical cell to the further cell terminal after the pressure in the interior of the housing exceeded a threshold pressure value;

FIG. 3 shows a schematic depiction of a material of the sealing element, which comprises a plastic material that itself is not electrically conductive and an electrically conductive phase of an electrically conductive additive, the proportion of the electrically conductive additive being set such that the sealing element has neither too high nor too low an electrical conductivity;

FIG. 4 shows a schematic depiction of a material of the sealing element, which comprises a plastic material that itself is not electrically conductive and an electrically conductive phase of an electrically conductive additive, the proportion of the electrically conductive additive being too low to make the sealing element electrically conductive;

FIG. 5 shows a schematic depiction of a material of the sealing element, which comprises a plastic material that itself is not electrically conductive and an electrically conductive phase of an electrically conductive additive, the proportion of the electrically conductive additive being so high that the sealing element has too high an electrical conductivity;

FIG. 6 shows a schematic sectional depiction corresponding to FIG. 1 of a second embodiment of the electrochemical cell in which the through-opening of the housing on which the sealing element is arranged is bounded by a collar;

FIG. 7 shows a schematic sectional depiction, corresponding to FIG. 1, of a third embodiment of the electrochemical cell in which the cell terminal of the electrochemical cell on which the sealing element is arranged comprises a bent sheet metal part; and

FIG. 8 comprises a sectional depiction, corresponding to FIG. 1, of a fourth embodiment of the electrochemical cell in which the cell terminal on which the sealing element is arranged has an elastically deformable region that comprises a plurality of bend lines.

The same or functionally equivalent elements are provided with the same reference numerals in all Figures.

### DETAILED DESCRIPTION OF THE INVENTION

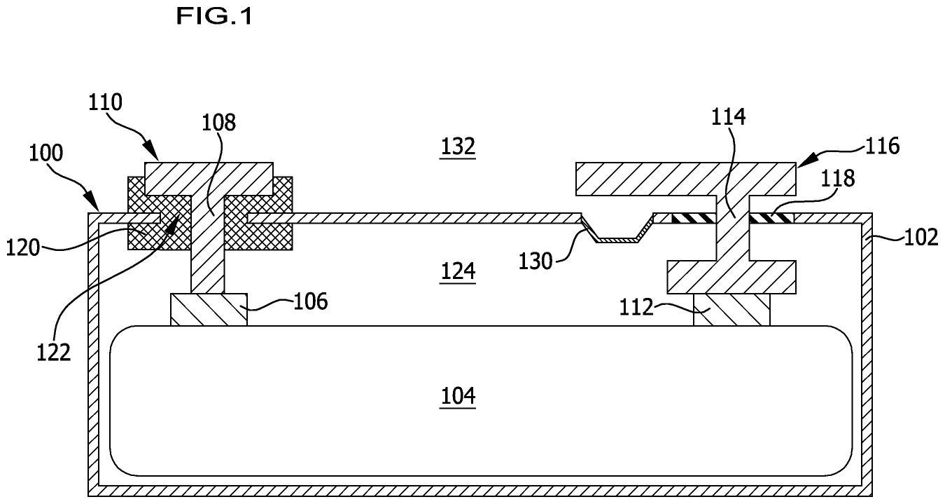

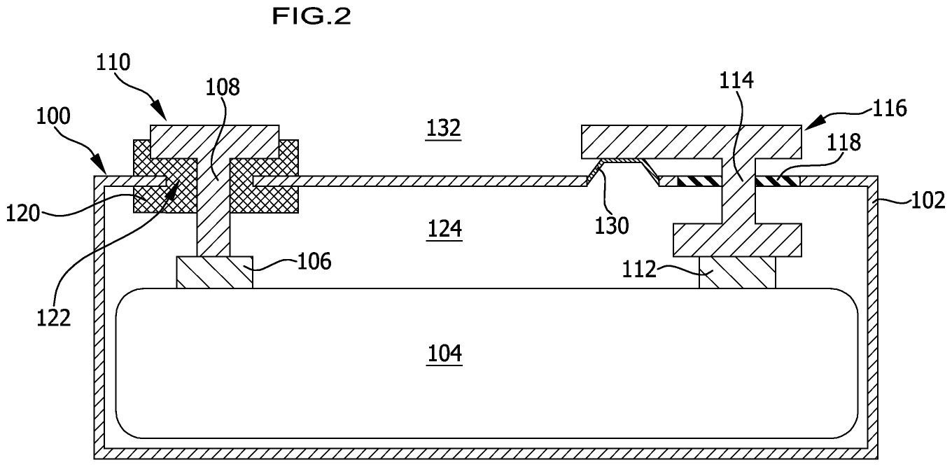

An electrochemical cell, depicted in FIGS. 1 and 2 and denoted as a whole with 100, comprises a housing 102, which may be of one- or two-part configuration, an electrochemical element 104 arranged in the housing 102, which is electrically conductively connected to a terminal feed-through 108 of a first cell terminal 110 by way of a first connecting conductor 106 and is electrically conductively connected to a terminal feed-through 114 of a second cell terminal 116 by way of a second connecting conductor 112, and an electrical insulating element 118, by means of which the terminal feed-through 114 of the second cell terminal 116 is electrically insulated from the housing 102.

Furthermore, the electrochemical cell 100 comprises an electrically conductive sealing element 120, which seals a through-opening 122 of the housing 102 of the electrochemical cell 100, through which through-opening 122 the terminal feed-through 114 of the first cell terminal 110 extends from the outside space of the housing 102 into its interior 124.

Furthermore, the sealing element 120 electrically conductively connects the first cell terminal 110 to the housing 102 of the electrochemical cell 100.

The sealing element 120 comprises, for example, a plastic material and an electrically conductive additive.

The plastic material may be, in particular, a thermoplastic material, for example a polypropylene material or a polybutylene terephthalate material.

When using a thermoplastic material, the sealing element is preferably produced in situ on the through-opening 122 of the housing 102 by an injection molding operation.

Alternatively hereto, provision may be made that the sealing element 120 comprises a thermosetting material, for example an epoxy resin material.

In this case, the sealing element 120 is preferably produced in situ on the through-opening 122 of the housing 102 of the electrochemical cell 100 by a casting operation.

The electrically conductive additive 126 contained in the sealing element 120 may comprise, for example, metallic particles, in particular aluminum particles, and/or a carbonaceous material, for example graphite and/or soot.

The electrical conductivity of the sealing element 120 can be set in a targeted manner by the proportion of the conductive additive 126 in the material of the sealing element 120.

If the proportion of the conductive additive 126 that is embedded in the plastic matrix 128 of the sealing element 120 in the material of the sealing element 120 is too low, as schematically depicted in FIG. 4, then no continuous electrically conductive percolation paths arise in the sealing element 120, such that the sealing element 120 has no electrical conductivity.

If the proportion of the conductive additive 126 in the material of the sealing element 120 is too high, as schematically depicted in FIG. 5, then the sealing element 120 has too low an electrical resistance to bring about a current limitation of the short circuit path between the first cell terminal 110 and the second cell terminal 116.

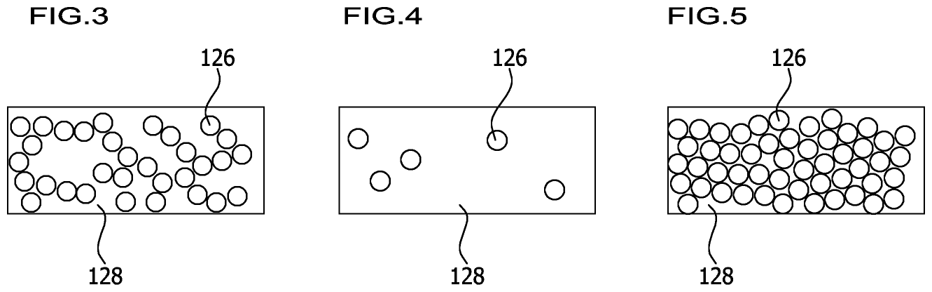

The proportion of the conductive additive 126 in the material of the sealing element 120 is therefore, as depicted in FIG. 3, selected such that the sealing element 120 forms a desired ohmic contact resistance between the first cell terminal 110 and the housing 102 of the electrochemical cell 100 in the range of preferably about 1·10¹Ω to about 1·10⁷Ω.

The specific electrical conductivity of the material of the sealing element 120 is preferably at least 10⁻³ S/m and preferably at most 10³ S/m.

Alternatively to the use of a plastic material that itself is not conductive and an electrically conductive additive, the desired electrical conductivity of the sealing element 120 can also be produced by using a plastic material that itself is electrically conductive, in particular a plastic material made electrically conductive by doping.

In particular, the sealing element 120 may be made, for example, from a doped polyacetylene material, from a doped polypyrrole material, from a doped polyaniline material, from a doped poly(p-phenylene) material, or from a doped polythiophene material.

When using a plastic material made electrically conductive by doping, the conductivity of the sealing element 120 can be set by the doping level of the plastic material used.

Furthermore, the electrochemical cell 100 comprises a snap-over element 130, which is arranged opposite the second cell terminal 116 on the housing 102 of the electrochemical cell 100.

In the normal operating state of the electrochemical cell 100 depicted in FIG. 1, the snap-over element 130 is in a rest state in which the snap-over element 130 projects into the interior 124 of the housing 102.

When the pressure in the interior 124 of the housing 102 exceeds a threshold pressure value, the snap-over element 130 then transitions from this rest state into the working state depicted in FIG. 2 in which the snap-over element 130 projects into the outside space 132 of the housing 102.

An increase in the pressure in the interior 124 of the housing 102 beyond the threshold pressure value is, in particular, caused by electrochemical processes and by the development of heat when the electrochemical cell 100 is overcharged.

In the working state of the snap-over element 130 depicted in FIG. 2, which corresponds to a short circuit state of the electrochemical cell 100, the first cell terminal 110 and the second cell terminal 116 of the electrochemical cell 100 are electrically conductively connected to one another by way of the sealing element 120, the housing cover 102, and the snap-over element 130, such that the electrochemical cell 100 is short circuited.

Due to the short circuit between the first cell terminal 110 and the second cell terminal 116, the electrochemical cell 100 is discharged in a controlled manner.

The short circuit reduces the potential difference between the first cell terminal 110 and the second cell terminal 116, which is detectable by means of a battery management system (BMS)—which is not depicted—to which the electrochemical cell 100 is connected.

The BMS can cancel a charging operation on the electrochemical cell 100 or on all electrochemical cells 100 of a cell module of an electrochemical device upon detection of a short circuit of the electrochemical cell 100.

Alternatively or in addition hereto, a warning message can be generated by the BMS, for example by means of suitable software, upon detection of a short circuit on the electrochemical cell 100.

Then, for example, a charging operation on the electrochemical cell 100 can be manually canceled on the basis of such a warning message.

Because the sealing element 120 has a sufficiently high current limiting resistance in the short circuit path of the electrochemical cell 100, the short circuit current is limited by the housing 102 and the snap-over element 130, such that damage to the snap-over element 130, which would interrupt the short circuit current path, is excluded.

This prevents the electrochemical cell 100 from being further overcharged and brought into a critical state.

In a variant (not depicted) of the electrochemical cell 100, a current flow interrupting device is provided, which, for example, comprises a fuse and interrupts the charging current that is applied to the electrochemical cell 100, such that an overcharging of the electrochemical cell 100 is prevented in this case, too.

Furthermore, the safety of the electrochemical cell 100 is increased by the current-limiting resistance of the sealing element 120, since the current flowing is limited in the case of unintentional contact of the housing 102 of the electrochemical cell 100 and thus the risk of an electrical shock is reduced.

The first cell terminal 110 on which the sealing element 120 is arranged may be a negative cell terminal or a positive cell terminal of the electrochemical cell 100.

The second cell terminal 116, adjacent to which the snap-over element 130 is arranged, has the respective opposite polarity to the first cell terminal 110, and is thus configured as a positive cell terminal or as a negative cell terminal.

If the first cell terminal 110 is a positive cell terminal and the second cell terminal 116 is a negative cell terminal, the housing 102 is preferably made primarily of aluminum.

If the first cell terminal 110 is a negative cell terminal and the second cell terminal 116 is a positive cell terminal, the housing 102 is preferably made of a stainless steel material.

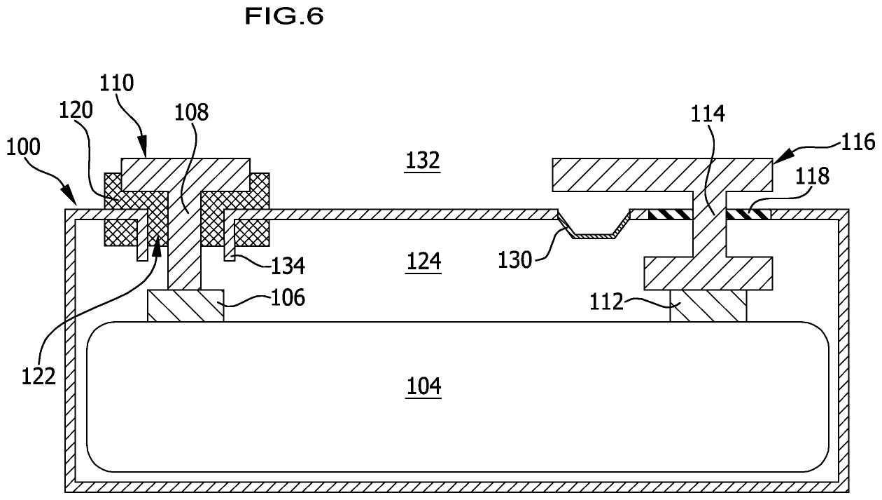

A second embodiment depicted in FIG. 6 of an electrochemical cell 100 differs from the first embodiment depicted in FIGS. 1 to 5 in that the through-opening 122 of the housing 102 through which the terminal feed-through 114 of the first cell terminal 110 on which the sealing element 120 is arranged extends is bounded by a collar 134.

The collar 134 may be formed on the housing 102, for example, by a deep drawing operation.

The collar 134 on the through-opening 122 of the housing 102 may, in principle, project into the outside space 132 of the housing 102 or into the interior 124 of the housing 102.

The collar 134 preferably projects into the interior 124 of the housing 102.

The size of the sealing face between the sealing element 120 and the housing 102 of the electrochemical cell 100 is increased by the collar 134, which improves the tightness of the seal created by the sealing element 120.

In addition, the composite adhesion between the sealing element 120 and the housing 102 is improved by the presence of the collar 134, in particular by the plastic material of the sealing element 120 shrinking onto the collar 134.

In all other respects, the second embodiment of an electrochemical cell 100 depicted in FIG. 6 corresponds with respect to structure, function, and production method with the first embodiment depicted in FIGS. 1 to 5, to the preceding description of which reference is made in this regard.

In the embodiment depicted in FIGS. 1 to 6 of an electrochemical cell 100, the first cell terminal 110 on which the sealing element 120 is arranged is of substantially T-shaped configuration in cross section, the base of the “T” forming the terminal feed-through 114, which extends through the through-opening 122 of the housing 102 of the electrochemical cell 100.

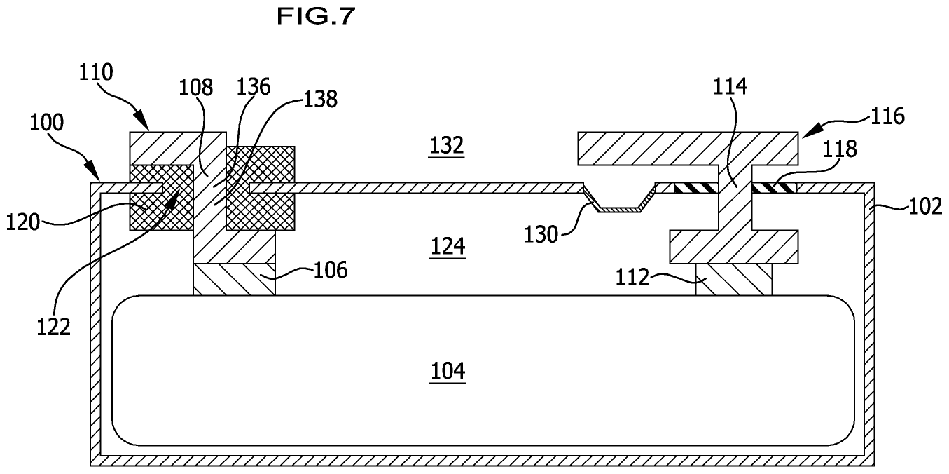

A third embodiment depicted in FIG. 7 of an electrochemical cell 100 differs from the first embodiment depicted in FIGS. 1 to 5 in that the first cell terminal 110 on which the sealing element 120 is arranged comprises a component 136 that has a substantially S-shaped or Z-shaped longitudinal section.

The component 136 may be configured, in particular, as a bent sheet metal part 138.

The component 136 can be separated out, for example punched out or cut out—e.g. by means of a laser—from a metal sheet made of a suitable starting material and then be bent into the desired form.

The component 136 is subsequently adhesively bonded to the housing 102 of the electrochemical cell 100 by means of the material of which the sealing element 120 is made.

The material from which the component 136 is separated out may have a material transition, in particular between a first region that is made, e.g., primarily of aluminum, and a second region that is made, e.g., primarily of copper.

These two regions of the starting material for the component 136 may be connected to one another, e.g., by overlap roll cladding.

In this case, the component 136 is separated out, in particular punched out or cut out—for example by means of a laser—from an overlap roll cladded starting sheet metal material and is subsequently bent into the desired form, for example an S-shape or a Z-shape.

Due to this manner of production, the number of components required for the first cell terminal 110 and the expenditure for the production of the first cell terminal 110 can be reduced.

In all other respects, the third embodiment of an electrochemical cell 100 depicted in FIG. 7 corresponds with respect to structure, function, and production method with the first embodiment depicted in FIGS. 1 to 5, to the preceding description of which reference is made in this regard.

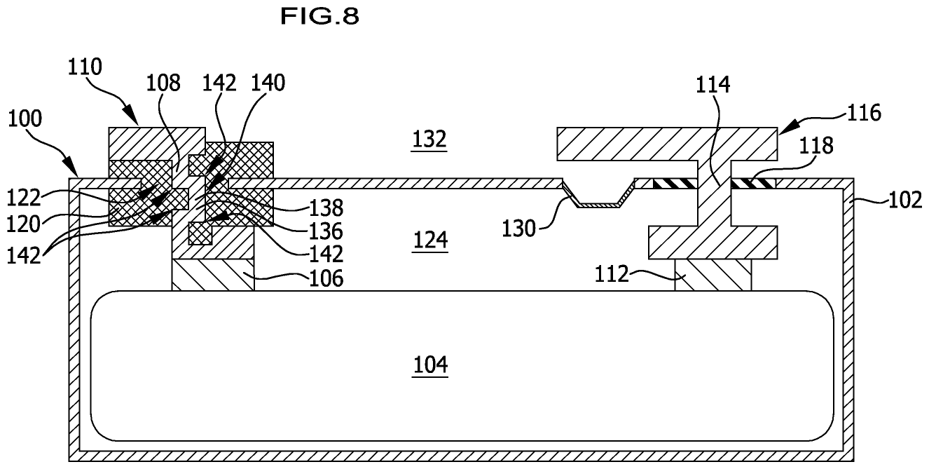

A fourth embodiment depicted in FIG. 8 of an electrochemical cell 100 differs from the third embodiment depicted in FIG. 7 in that the first cell terminal 110 on which the sealing element 120 is arranged comprises an elastically deformable region 140.

Forces acting on the sealing element 120 and/or on the first cell terminal 110 that are generated, for example, by a movement of the electrochemical element 104 upon an impact load can be absorbed by this elastically deformable region 140 without the sealing function of the sealing element 120 being impaired.

Provision is preferably made that the elasticity of the elastically deformable region 140 is based on a dimensional elasticity that is caused by at least one additional bend of the component 136.

In the embodiment that is graphically depicted in FIG. 8, the elastically deformable region 140 comprises, as an example, four bend lines 142 at which the component 136 configured as a sheet metal part 138 is bent by an angle of about 90°.

Together the bends at the bend lines 142 produce a wave shape of the elastically deformable region 140.

In all other respects, the fourth embodiment of an electrochemical cell 100 depicted in FIG. 8 corresponds with respect to structure, function, and production method with the third embodiment depicted in FIG. 7, to the preceding description of which reference is made in this regard.

In principle, an electrochemical cell 100 may have and combine any combinations of the features of the embodiments of electrochemical cells 100 described above and depicted in FIGS. 1 to 8.

1. An electrochemical cell, comprising
a housing,
an electrochemical element arranged in an interior of the housing, and
at least one cell terminal, which comprises a terminal feed-through that extends through a through-opening of the housing,
wherein the electrochemical cell comprises an electrically conductive sealing element, which seals the through-opening of the housing and electrically conductively connects the cell terminal to the housing.

2. The electrochemical cell in accordance with claim 1, wherein the sealing element comprises a plastic material.

3. The electrochemical cell in accordance with claim 1, wherein the sealing element comprises at least one of a polypropylene material, a polybutylene terephthalate material, and an epoxy resin material.

4. The electrochemical cell in accordance with claim 1, wherein the sealing element comprises an electrically conductive additive.

5. The electrochemical cell in accordance with claim 4, wherein the electrically conductive additive comprises at least one of metallic particles, an electrically conductive carbon modification, and an electrically conductive ceramic material.

6. The electrochemical cell in accordance with claim 1, wherein the sealing element comprises a plastic material that is electrically conductive by doping.

7. The electrochemical cell in accordance with claim 6, wherein the sealing element comprises at least one of a doped polyacetylene material, a doped polypyrrole material, a doped polyaniline material, a doped poly(p-phenylene) material, a doped polythiophene material, a doped poly-3,4-ethylenedioxythiophene, and a doped polystyrene sulfonate (PEDOT:PSS).

8. The electrochemical cell in accordance with claim 1, wherein the sealing element is configured as an injection molded part or as a casting compound part.

9. The electrochemical cell in accordance with claim 1, wherein the cell terminal on which the sealing element is arranged is a positive cell terminal of the electrochemical cell.

10. The electrochemical cell in accordance with claim 1, wherein the electrochemical cell comprises a further cell terminal and a snap-over element, which brings the housing of the electrochemical cell into electrically conductive contact with the further cell terminal when a pressure in the interior of the housing of the electrochemical cell exceeds a threshold pressure value.

11. The electrochemical cell in accordance with claim 1, wherein the housing of the electrochemical cell comprises at least one of aluminum and a stainless steel material.

12. The electrochemical cell in accordance with claim 1, wherein the cell terminal comprises a bent sheet metal part.

13. The electrochemical cell in accordance with claim 1, wherein the cell terminal comprises an elastically deformable region.

14. The electrochemical cell in accordance with claim 13, wherein the elastically deformable region comprises at least one bend.

15. The electrochemical cell in accordance with claim 1, wherein the through-opening of the housing is bounded by a collar.

16. A method for producing an electrochemical cell, wherein the electrochemical cell comprises a housing, an electrochemical element arranged in the interior of the housing, and at least one cell terminal that comprises a terminal feed-through,
wherein the method comprises the following:
arranging the cell terminal relative to the housing in such a way that the terminal feed-through extends through a through-opening of the housing;
producing an electrically conductive sealing element, which seals the through-opening and electrically conductively connects the cell terminal to the housing, from a plastic material that at least one of a) comprises an electrically conductive additive and b) is electrically conductive by doping.
